(19) United States
(12) Patent Application Publication
(10) Pub. No.: US 2007/0030992 A1
(43) Pub. Date: Feb. 8, 2007

(54) Low frequency loudspeaker enclosure

(76) Inventor: Kenneth M. Rauen, Palo Alto, CA (US)

Correspondence Address: Kenneth M. Rauen, Apt. 212, 345 Sheridan, Palo Alto, CA, 94306, US

(21) Appl. No.: 11/487,255

(22) Filed: Jul. 13, 2006

Related U.S. Application Data
(60) Provisional application No. 60/706,394, filed on Aug. 3, 2005.

(51) Int. Cl. H04R 1/02; H04R 1/20

(52) U.S. Cl. 381/351

(57) ABSTRACT

A low frequency loudspeaker enclosure with unique applications for recoil-canceling configurations. Vibration of the enclosure is reduced sufficiently to use the loudspeaker enclosure in dual use as common furniture, such as an end table, a coffee table, a bookshelf, or as an entertainment center. Enclosure shapes also allow placement behind or under couches and beds without dual use as furniture.

### CROSS-REFERENCE TO RELATED APPLICATIONS

This application is entitled to the benefit of Provisional Patent Application Ser. No. 60/706394, filed Aug. 3, 2005.

### STATEMENT REGARDING FEDERALLY SPONSORED RESEARCH AND DEVELOPMENT

Does not apply.

### REFERENCE TO A MICROFICHE APPENDIX

Does not apply.

### BACKGROUND

1Field of Invention

The present invention relates to loudspeaker enclosures, specifically to applications in domestic listening environments.

2. Description of Prior Art

Loudspeaker systems are usually comprised of one or more electro-acoustic transducers mounted in an enclosure or baffle. Typical transducer configurations produce enclosure/baffle vibrations at low frequencies because of recoil forces. This is particularly true for subwoofer loudspeaker enclosures. The prior art has eliminated this vibration by placing multiple, low frequency transducers and other acoustically active elements in mirror-image positions to cancel the recoil forces. Cabinet/enclosure vibrations make subwoofers unsuitable as multiple use devices such as end tables, coffee tables, bookshelves, or entertainment centers. Recoil-canceling loudspeaker enclosure designs, including subwoofer designs, have not been applied to multiple use applications; these loudspeakers have been used only as loudspeakers.

Subwoofers are typically not sensitive to location in a listening room.

Subwoofer placement is usually limited by decor aesthetics. This is due in part by the commonly used shape of the subwoofer enclosure as a cube the size of a bookshelf loudspeaker.

### SUMMARY OF THE INVENTION

In accordance with the present invention, subwoofers of recoil-less design are shaped like common furniture and function like common furniture in dual use as furniture and as subwoofers. When room decor does not allow application as dual-use furniture, the subwoofer enclosures of the present invention are hidden by placement behind or underneath conventional furniture, allowed by their unique shape. In a first embodiment, a subwoofer enclosure is shaped and used as a bookshelf. In a second embodiment, a subwoofer enclosure is shaped and used as an end table. In a third embodiment, a subwoofer enclosure is shaped and used as a coffee table. In a fourth embodiment, a subwoofer enclosure is built into an entertainment center. In a fifth embodiment, a subwoofer enclosure is shaped for hidden placement underneath or behind a couch, bed, or entertainment center.

Objects and Advantages

Accordingly, several objects and advantages of my invention are as follows. Subwoofer enclosures can be placed out in the open in a typical living room domestic environment because the enclosures look like and function like common pieces of furniture, such as bookshelves, end tables, coffee tables and entertainment centers; it is no longer necessary to hide a subwoofer enclosure because of issues of room decor. Loudspeakers are often made presentable and acceptable in living room decor by the use of fine wood finishes and other visual aesthetic considerations, but such loudspeakers remain a single use item in the living space. The enclosures of the present invention allow subwoofers to also serve as functional furniture because of the vibration-less designs patented in the prior art. The prior art never usefully applied recoil-less designs other than for reasons of high fidelity, that the acoustically active elements, such as transducers, ports, and passive radiators, should be the only vibrating members of the loudspeakers. The lack of vibration of the enclosures due to recoil-less design is also useful to the homeowner by using the subwoofer for more than just music. Books, magazines, lamps, potted plants, plates of food, and cups and glasses of drinks, among other things, may be placed on top of these enclosures without concern for vibration, movement, spilling, or falling. Because these novel uses are apparent to the homeowner and guests once the uses are recognized, such enclosures will not stand out visually as out of place with the rest of the furniture in the room. It becomes easier for the homeowner to blend his or her sound system into the existing room arrangement with this invention. Some recoil-less subwoofers currently on the market do not have top surfaces conducive to the placement of books, lamps, and other common items. The enclosures of the present invention are flat-topped like the furniture they imitate and they have dimensions that are expected of the furniture they imitate.

When placement in a highly visible location is unacceptable or when space is not available, another enclosure embodiment can solve the subwoofer placement problem. Locating the enclosure underneath or behind a couch or a bed or an entertainment center can place the loudspeaker enclosure unobtrusively out of the way. Even though floor space is occupied in locations behind furniture, such space utilization is sometimes acceptable whereas use of open floor space is not acceptable. One dimension of the enclosure is very small, producing a “pancake” or “book” shape to the enclosure that is typically cubical, shoe-box shaped, or cylindrically shaped in the prior art.

Further objects of the present invention may become apparent from a consideration of the drawings and ensuing descriptions.

### BRIEF DESCRIPTION OF THE DRAWINGS

FIG. 1 shows a see-through configuration of a recoil-less subwoofer enclosure used in the applications of the present invention.

FIG. 2 shows an enclosure according to FIG. 1, used as a bookshelf with shelves in front of the subwoofer enclosure.

FIG. 3 shows a see-through configuration of a recoil-less subwoofer enclosure used as an end table.

FIG. 4 shows an enclosure according to FIG. 1 placed behind a couch and against a wall.

FIG. 5 shows an enclosure according to FIG. 1 placed underneath a couch.

FIG. 6 shows an enclosure according to FIG. 3 placed next to a chair.

FIG. 7 shows an enclosure built into an entertainment center.

FIG. 8 shows a see-through configuration of a recoil-less subwoofer enclosure with two sets of parallel panels with transducers mounted on the parallel panels.

FIG. 9 shows an enclosure according to FIG. 8, used as a coffee table.

FIG. 10 shows an enclosure according to FIG. 1 placed behind a bed.

FIG. 11 shows an enclosure according to FIG. 1 placed under a bed.

FIG. 12 shows an enclosure according to FIG. 1 placed behind an entertainment center.

### LIST OF REFERENCE NUMERALS

10 basic enclosure see-through view

11 enclosure panel

12 enclosure panel

13 enclosure panel

14 enclosure panel

15 enclosure panel

16 enclosure panel

17 cone woofer

18 port

20 bookshelf look-alike enclosure

21 enclosure panel

22 enclosure panel

23 enclosure panel

24 top shelf

25 front shelf

27 cone woofer

28 port

30 end table look-alike enclosure see-through view

31 enclosure panel

32 enclosure panel

33 enclosure panel

34 enclosure panel

35 enclosure panel

36 enclosure panel

37 cone woofer

38 port

40 behind-the-couch enclosure

41 couch

42 enclosure panel

43 enclosure panel

44 enclosure panel

45 wall

47 cone woofer

48 port

50 under-the-couch enclosure

51 couch

52 enclosure panel

53 enclosure panel

55 coaster

57 cone woofer

60 end table look-alike enclosure

61 chair

62 table lamp

63 enclosure panel

64 enclosure panel

65 enclosure panel

67 cone woofer

68 port

70 entertainment center enclosure

71 video monitor or television

72 enclosure panel

73 enclosure panel

74 enclosure panel

75 top shelf

76 front shelf

77 cone woofer

78 port

80 coffee table look-alike enclosure see-through view

81 enclosure top panel

82 enclosure bottom panel

83 enclosure side panel

84 enclosure side panel

85 enclosure side panel

86 enclosure side panel

87 cone woofer

88 port

90 coffee table look-alike enclosure

91 couch

92 table top

93 top enclosure panel

94 enclosure side panel

95 enclosure side panel

97 cone woofer

98 port

100 behind-the-bed enclosure

101 bed

102 enclosure panel

103 enclosure panel

104 enclosure panel

107 cone woofer

108 port

110 under-the-bed enclosure

111 bed

112 enclosure panel

113 enclosure panel

117 cone woofer

120 behind-the-entertainment-center enclosure

121 video monitor or television

122 enclosure panel

123 enclosure panel

124 enclosure panel

125 entertainment center

126 front shelf

127 cone woofer

128 port

### DETAILED DESCRIPTION OF THE INVENTION

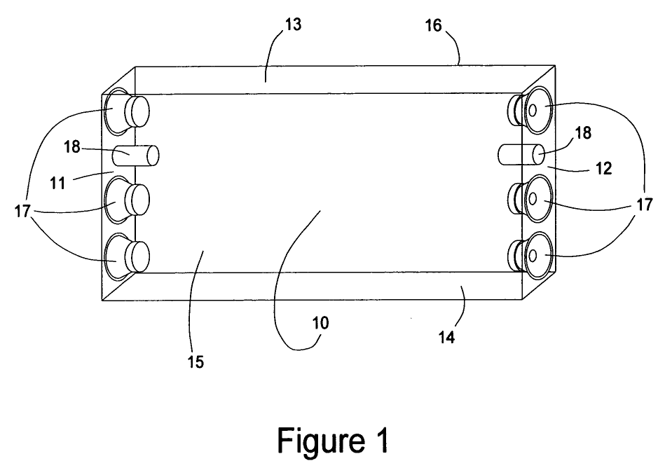

FIG. 1 shows in a see-through style the basic configuration of electro-acoustic transducers and other acoustically active elements in the enclosures of the present invention, such as ports or passive radiators. Enclosure 10 is composed of three pairs of parallel panels. Panels 11 and 12 form one pair. Panels 13 and 14 form another pair. Panels 15 and 16 form the third pair. In the preferred embodiments of FIGS. 1-7 and 12, only one pair of parallel panels is used for the acoustically active elements. On these two panels of enclosure 10 are each mounted three cone woofers 17 and one port 18. The number and size of acoustically active elements such as cone woofer 17 and port 18 are not limited and will vary with individual designs. The position of each acoustically active element is in a mirror-image configuration with respect to panels 11 and 12 and with respect to enclosure 10 in order to achieve true recoil-less performance. A passive radiator may be used in place of port 18, or may be eliminated for infinite baffle or acoustic suspension designs instead of the preferred embodiments as bass reflex designs. The dimensions of enclosure 10 are selected with one dimension substantially smaller than the other two for the purpose of minimizing one dimension to utilize novel placement options not available in the prior art. The utility of the small panel dimension usually results in the blockage of one or both panels that have the largest dimensions, panels 15 and 16, because of adjacent walls or furniture. This precludes the placement of the acoustically active components on those panels. Panels 11 and 12 are exposed to the air of the listening environment and radiate acoustic output substantially unrestricted. Panel 13 may be used as a shelf to place objects upon. Within the dimensions normally encountered in domestic environments, frequencies below 100 Hz which are the typical spectrum of subwoofers, do not produce a localization cue. The acoustically active elements also act as one element at frequencies below 100 Hz. The acoustically active elements on opposite panels have no deleterious effect upon the sonic image produced.

All acoustically active elements in the preferred embodiments of this invention are mounted in opposite, mirror imaged panels.

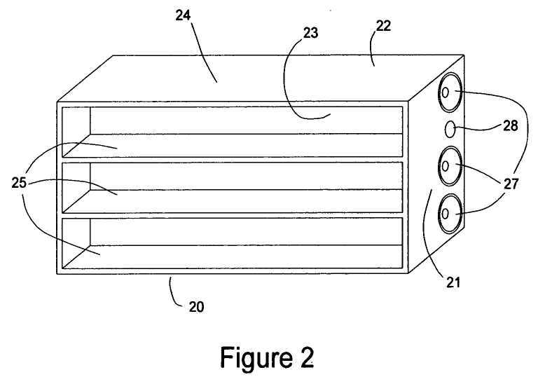

FIG. 2 shows enclosure 20 in dual use as a bookshelf. It has acoustically active elements on two parallel panels like shown in FIG. 1, but only one of those panels, panel 21, is shown with three cone woofers 27 and one port 28. The mirror-image panel is not shown for the sake of clarity of presentation of the embodiment as a bookshelf-look-alike. Adjacent panels 22 and 23 are shown, but also without their mirror-image panels. Refer to FIG. 1 for the configuration that applies to the hidden structures of FIG. 2. The top of the enclosure, top shelf 24, is wide enough for large books and the front shelves 25 are for smaller books. The subwoofer portion of the embodiment is behind shelves 25. Enclosure 20 may be used as a shelf or shelves for books and other items.

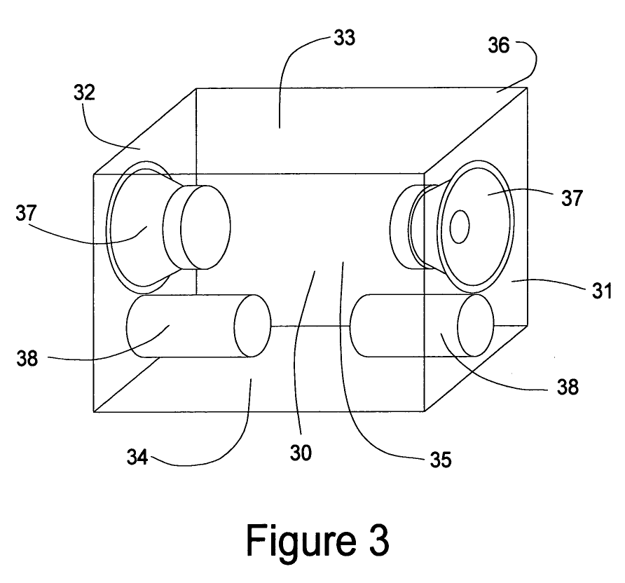

FIG. 3 shows a see-through configuration of this invention as an end table. Enclosure 30 has three pairs of parallel panels that are close to the same dimension and mimic the size and shape of conventional end table furniture. Panels 31 and 32 form one parallel set and have the acoustically active elements, cone woofers 37 and ports 38, mounted on them in a mirror-image configuration. Panels 33 and 34 form the top and bottom panels. Panels 35 and 36 form the side panels.

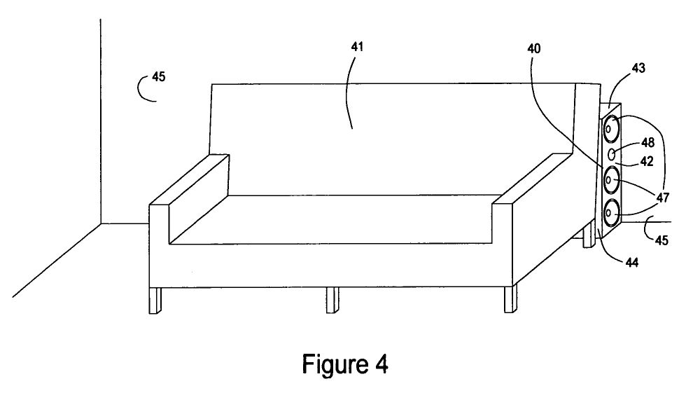

FIG. 4 shows the enclosure 40 in the configuration of FIG. 1 which is placed in the application of a behind-the-couch subwoofer. Enclosure 40 is placed behind the couch 41 and in front of the wall 45 with substantially no clearance between the wall 45 and the couch 41. Couch 41 substantially hides enclosure 40 from view. Enclosure panels 42, 43, and 44 are visible at the edge of couch 41. On panel 42 are mounted cone woofers 47 and port 48. Locating subwoofer enclosure 40 so close to a listening position on couch 41 creates an additional sonic experience of feeling the low frequencies through couch 41. Refer to FIG. 1 for the configuration that applies to the hidden structures of FIG. 4.

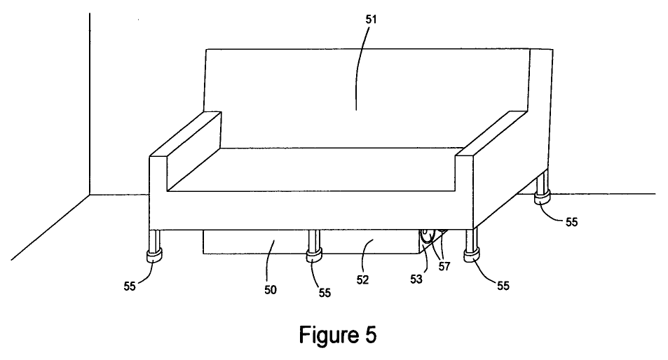

In FIG. 5, enclosure 50 is located below couch 51. Only two panels of enclosure 50 are visible in this view, panels 52 and 53. Two cone woofers 57 are visible on panel 53. Couch 51 is propped up on coasters 55. Some couches will accept enclosure 50 without coasters 55 but many will require coasters 55 to provide enough clearance. Just like in FIG. 4, locating enclosure 50 so close to a listening position on couch 51 creates an additional sonic experience of feeling the low frequencies through couch 51. The configuration of FIG. 1 applies to enclosure 50. Refer to FIG. 1 for the configuration that applies to the hidden structures of FIG. 5.

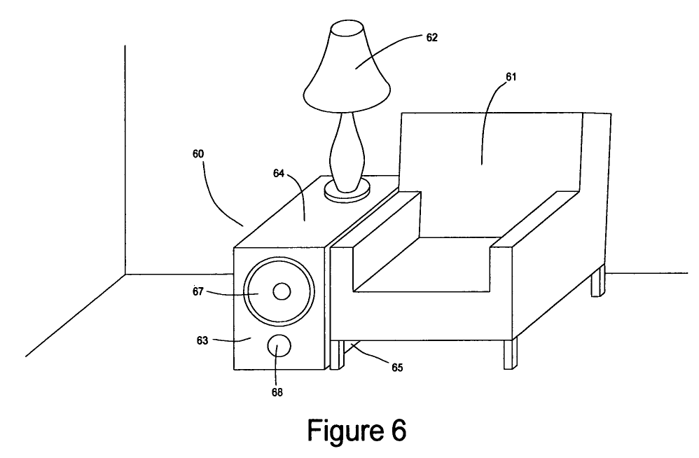

FIG. 6 displays enclosure 60 in dual use as a subwoofer and an end table. Next to enclosure 60 is a chair 61, and on top of enclosure 60 is table lamp 62. Enclosure panels 63, 64, and 65 are visible from this viewpoint. On panel 63 are mounted cone woofer 67 and port 68. The configuration of FIG. 3 applies to enclosure 60. Refer to FIG. 3 for the configuration that applies to the hidden structures of FIG. 6.

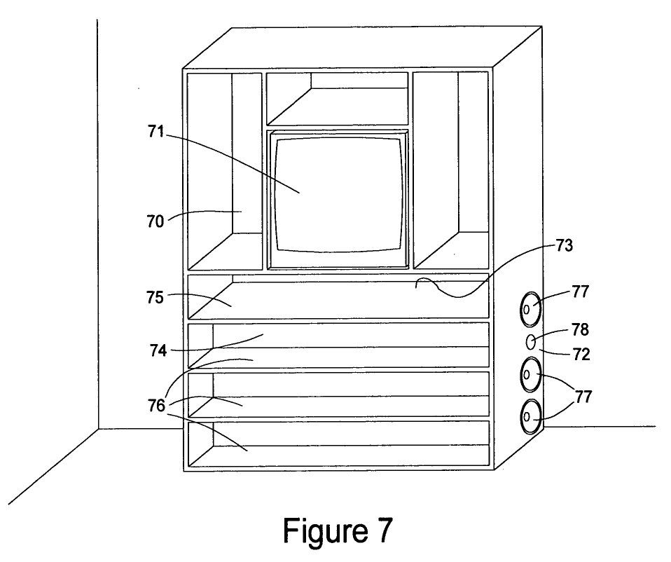

FIG. 7 shows enclosure 70 in dual use as a subwoofer and as an entertainment center. Enclosure 70 is shown with a video monitor or television 71. Three of the six panels composing the acoustic enclosure within enclosure 70 in the same configuration as with FIG. 1 are visible as panels 72, 73, and 74. The entertainment center shelves hide the subwoofer enclosure. Woofers 77 and port 78 are visible on panel 72. Top shelf 75 is the same surface as enclosure panel 73. Front shelves 76 cover enclosure panel 74. Vibration is so low from the subwoofer enclosure that audio and video components are expected to be substantially undisturbed by the vibrational output through the enclosure, including vinyl LP turntables that use modest isolation techniques. Refer to FIG. 1 for the configuration that applies to the hidden structures of FIG. 7.

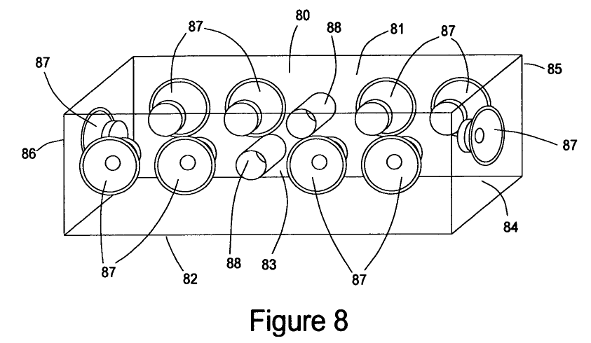

FIG. 8 shows a see-through configuration of enclosure 80. Two parallel sets of panels have acoustically active elements. Panels 81 and 82 are the top and the bottom panels and contain no acoustically active elements. Cone woofers 87 and ports 88 may be used throughout panels 83-86 in any configuration so long as they exist in mirrored pairs for substantial vibration cancellation essential to this application.

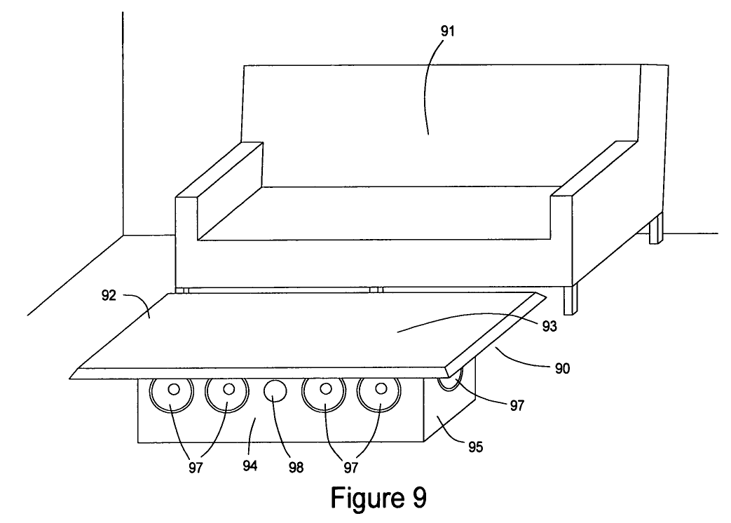

FIG. 9 shows coffee table enclosure 90 in front of couch 91. Table top 92 is also subwoofer enclosure panel 93. Only two side panels 94 and 95 are seen in this view, containing cone woofers 97 and port 98 in the configuration of FIG. 8. The coffee table embodiment is not a preferred embodiment. Woofers 97 are too easily exposed to damage from accidental foot motion from people seated on chairs and couches surrounding coffee table enclosure 90. Woofers 97 are shown elevated off the floor, which will reduce exposure to mechanical damage. Refer to FIG. 8 for the configuration that applies to the hidden structures of FIG. 9.

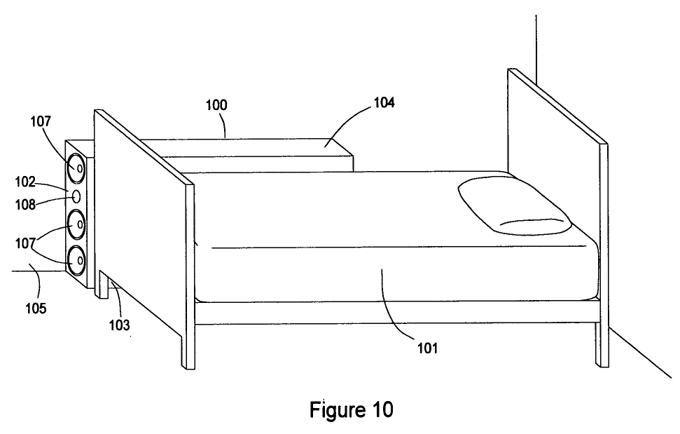

FIG. 10 shows enclosure 100 in the configuration of FIG. 1 behind bed 101. Enclosure 100 is placed behind bed 101 and in front of wall 105 with substantially no clearance between the wall 105 and bed 101. Bed 101 substantially hides enclosure 100 from view. Enclosure panels 102, 103, and 104 are visible at the edge of bed 101. On panel 102 are mounted cone woofers 107 and a port 108. Refer to FIG. 1 for the configuration that applies to the hidden structures of FIG. 10.

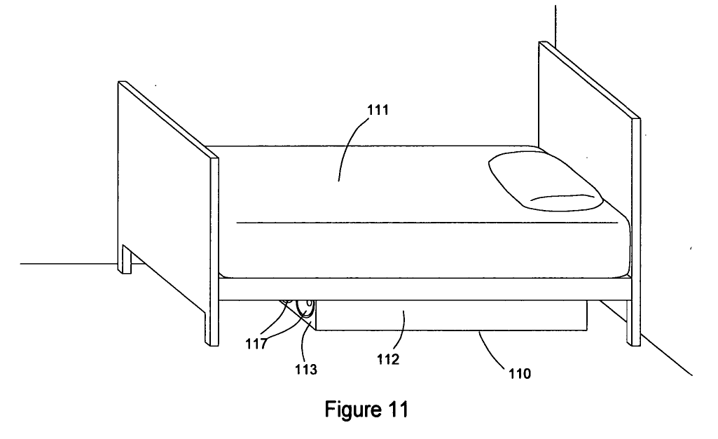

FIG. 11 shows enclosure 110 in the configuration of FIG. 1 under a bed 111. Bed 111 substantially hides enclosure 110 from view. Enclosure panels 112 and 113 are visible under the bed 111. On panel 113 are visible two woofers 117. Refer to FIG. 1 for the configuration that applies to the hidden structures of FIG. 11.

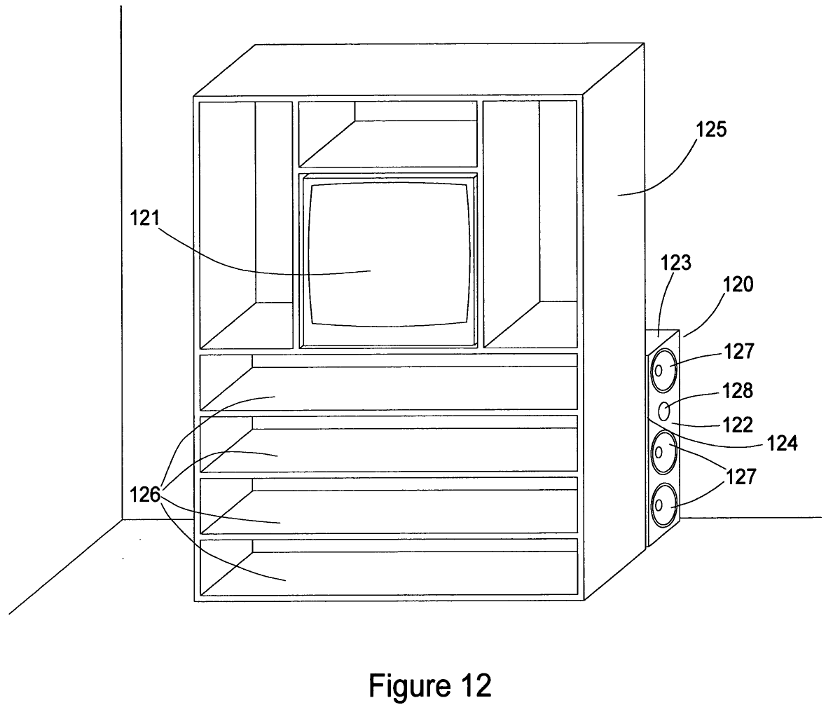

FIG. 12 shows enclosure 120 behind entertainment center 125 which contains video monitor or television 121. Three of the six panels composing enclosure 120 are visible as panels 122, 123, and 124. Woofers 127 and port 128 are visible on one side of entertainment center 125, on panel 122. Front shelves 126 hide enclosure panel 120. Refer to FIG. 1 for the configuration that applies to the hidden structures of FIG. 12.

The enclosure designs of FIGS. 1, 4, 5, 10, 11, and 12 do not require recoil-less designs. End table, coffee table, bookshelf, and built-into-the-entertainment-center applications, as shown in FIGS. 2, 3, 6, 7, 8, and 9, do require recoil-less designs.

Conclusion, Rammifications, and Scope of Invention

Thus the reader will see that the subwoofer enclosures of the present invention allow the consumer to place subwoofers in locations that the prior art had difficulty doing. Dual use as a subwoofer and as room furniture by placement of common objects upon the enclosure creates a novel application that did not exist or was not utilized in the prior art. Where dual use in highly visual locations is not acceptable or where space is not available for another loudspeaker, hidden loudspeaker enclosure placement behind or underneath existing furniture solves the placement issue. The extension of the prior art of subwoofer enclosure design to the specific mimicking of common furniture, and going beyond that by a large change in typical enclosure dimensions in order to hide them, allow new applications of subwoofer placement in domestic listening environments.

The narrow designs of the bookshelf and behind-the-furniture applications create an under-utilized advantage in domestic listening environments for small woofers. At low frequencies, acoustic coupling of multiple transducers occurs, raising the efficiency of the individual transducers. This provides a design advantage whereby lower efficiency, smaller diameter transducers may be used to achieve the same displacements and sound pressure levels as traditional, larger diameter woofers of the prior art with the same input power. Smaller transducers typically have higher free air resonant frequencies and those resonances can be lowered by adding mass to achieve the desired frequency response range. Efficiency coupling of multiple drivers offsets the reduction in efficiency from adding mass. Comparable performance to the prior art is achieved without altering normal room decor.

What I claim is:

1. A subwoofer comprising an enclosure containing six panels of three parallel pairs of panels, wherein the improvements comprise:
a) the outside dimensions of said enclosure relative to the smallest outside dimension with minimum ratios of 2.5:1 for one larger dimension to said smallest dimension and 2.5:1 for the other larger dimension to said smallest dimension, and
b) acoustically active elements mounted on at least one of said panels containing said smallest dimension,
whereby enclosure shape gives said loudspeaker system new placement locations in a listening environment.

2. Said subwoofer according to claim 1, wherein acoustically active elements are mounted in one or two parallel pairs of said panels.

3. Said subwoofer according to claim 1, wherein the upper panel of said panels of said enclosure is used as a shelf for placement of objects thereupon.

4. Said subwoofer according to claim 1, wherein said enclosure contains attached shelves.

5. Said subwoofer according to claim 1, wherein said enclosure containing said smallest dimension is placed underneath a couch.

6. Said subwoofer according to claim 1, wherein said enclosure containing said smallest dimension is placed between a couch and a wall.

7. Said subwoofer according to claim 1, wherein said enclosure containing said smallest dimension is placed underneath a bed.

8. Said subwoofer according to claim 1, wherein said enclosure containing said smallest dimension is placed between a bed and a wall.

9. Said subwoofer according to claim 1, wherein said enclosure is built into an entertainment center.

10. Said subwoofer according to claim 1, wherein said enclosure containing said smallest dimension is placed behind an entertainment center.

11. A method for disguising a subwoofer comprising dual use as common furniture and as a low frequency loudspeaker enclosure, wherein:
a) the outside dimensions of said enclosure are relative to the smallest outside dimension with minimum ratios of 2.5:1 for one larger dimension to said smallest dimension and 2.5:1 for the other larger dimension to said smallest dimension, and
b) acoustically active elements are mounted on said panels containing said smallest dimension,
whereby said subwoofer is hidden out in the open by performing common functions of furniture.

12. Said subwoofer according to claim 1l, wherein acoustically active elements are mounted in one or two parallel pairs of panels.

13. Said subwoofer according to claim 1 1, wherein said enclosure containing said smallest dimension is used as a bookshelf.

14. Said subwoofer according to claim 11, wherein said enclosure contains attached shelves.

15. Said subwoofer according to claim 11, wherein said enclosure containing said smallest dimension is placed underneath a couch.

16. Said subwoofer according to claim 1, wherein said enclosure containing said smallest dimension is placed between a couch and a wall.

17. Said subwoofer according to claim 11, wherein said enclosure containing said smallest dimension is placed underneath a bed.

18. Said subwoofer according to claim 1 1, wherein said enclosure containing said smallest dimension is placed between a bed and a wall.

19. Said subwoofer according to claim 11, wherein said enclosure is built into an entertainment center.

20. Said subwoofer according to claim 11, wherein said enclosure containing said smallest dimension is placed behind an entertainment center.

21. A subwoofer of recoil-less design comprising an enclosure containing six panels of three parallel pairs of panels, with acoustically active elements mounted on at least one said parallel pair of panels of said enclosure with the same number of said elements on each said parallel panel,
wherein said subwoofer is used as an end table or coffee table,
wherein an end table and coffee table are hereby each defined as a table near a couch or chair within arm's reach of a seated person on said couch or said chair, and said tables' height is less than 66 centimeters.

22. Said subwoofer according to claim 21, wherein acoustically active element placement may include a second parallel pair of panels.
